(19) United States
(12) Patent Application Publication
(10) Pub. No.: US 2012/0212056 A1
(43) Pub. Date: Aug. 23, 2012

(54) MODULARIZED BALANCING BRIDGE FOR MULTIPLE VOLTAGE SOURCES

(76) Inventors: Jeffrey Ewanchuk, Edmonton (CA); John Salmon, Edmonton (CA)

(21) Appl. No.: 13/235,257

(22) Filed: Sep. 16, 2011

(51) Int. Cl. H02J 1/00

(52) U.S. Cl. 307/43

(57) ABSTRACT

A balancing bridge module includes a magnetic core, an intra-module pair of windings around the core, each to couple to a separate voltage source, and at least one inter-module winding around the core to couple to an adjacent balancing module. Each of the intra-module and inter-module windings has an equal number of turns and operates to balance voltages between the separate voltage sources and an adjacent module if coupled.

### BACKGROUND

In applications where smaller voltage sources are serially connected to increase operating voltages, the potential exists for the individual voltage sources to become unbalanced. Therefore, a significant amount of research activity has been dedicated to solving voltage unbalances in a wide variety of applications, e.g., multi-level PWM converter systems, ultra-capacitors, and battery systems.

Due to their high charge density and high output power capability, lithium ion polymer batteries have shown to have great promise for modern electric vehicle systems. However, when compared to previous battery technology, lithium polymer batteries are much less tolerant to overcharging/discharging and can fail catastrophically from such conditions. Additionally, when placed in a series configuration to achieve higher operating voltages, the voltages of the individual battery cells should be equalized with each other in order to maximize energy storage. Thus, battery voltage equalization circuits play a significant role in the emergence of lithium ion battery technology, and therefore emerging applications such as electric vehicles.

In battery applications, many voltage balancing techniques have been used. In general, voltage balancing techniques can be split into two fields: dissipative and non-dissipative. The latter can be split into charge shuttling, charge shunting, and transformer based converter techniques.

In charge shunting (for non-dissipative approaches), battery cells are balanced by diverting charging current from higher charged cells to lower charged cells in a wide variety of approaches. For charge shuttling, switched capacitors move charge from the highest charged cells to the lowest by voltage equalization amongst the batteries and the capacitors. However, it is the transformer-based converter, where magnetic coupling is exploited to balance voltage differences across a battery string, which is the primary focus of this work.

In transformer based balancing circuits, DC/DC converter based single transformers with multiple windings have been demonstrated, along with various balancing circuits. One approach involves a flyback-derived balancing circuit that uses strings of battery cells to form a single module, and allows for voltage balancing between the cells of a given module and balancing between modules, allowing balancing of the battery string. In that approach, however, the transformers involved in the internal module balancing and the module-to-module balancing are different in terms of power rating and turns ratios, and power flow within a single module is unidirectional.

### SUMMARY

A balancing bridge module includes a magnetic core, an intra-module pair of windings around the core, each to couple to a separate voltage source, and at least one inter-module winding around the core to couple to an adjacent balancing module. Each of the intra-module and inter-module windings has an equal number of turns and operates to balance voltages between the separate voltage sources and an adjacent module, if coupled.

In one embodiment, a pair of switches is included. Each switch is coupled between a respective one of the intra-module pair of windings and a respective voltage source. A controller is coupled to switch the switches on and off in a time staggered or a time synchronized manner (e.g., to control the switches according to a particular duty cycle).

In a further embodiment, a method includes balancing, in a first module, a first intra-module voltage among multiple voltage sources, providing an inter-module balancing current to a second module, and balancing, in the second module, a second intra-module voltage among multiple other voltage sources. The balancing in both balancing modules includes using the inter-module balancing current.

The Summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A is a block schematic diagram of a balancing bridge module including power sources according to an example embodiment.

FIG. 1B is a schematic diagram of the balancing bridge module of FIG. 1A according to an example embodiment.

FIG. 1C is a block schematic diagram of a core with inter-module and intra-module windings according to an example embodiment.

FIG. 2A is an equivalent circuit diagram for the intra-bridge balancing currents, showing magnetizing current paths for positive excitation according to an example embodiment.

FIG. 2B is an equivalent circuit diagram for the intra-bridge balancing currents, showing magnetizing current paths for negative excitation according to an example embodiment.

FIG. 2C is an equivalent circuit diagram for the intra-bridge balancing currents, showing a differential current according to an example embodiment.

FIG. 3A is a graph illustrating winding currents for a single bridge, under an intra-bridge voltage unbalance, according to an example embodiment.

FIG. 3B is a graph illustrating the intra-bridge balancing current of a single module with increasing intra-bridge voltage difference according to an example embodiment.

FIG. 4 is a circuit diagram illustrating two balancing bridge modules coupled together according to an example embodiment.

FIG. 5A is an equivalent circuit diagram of the two balancing bridges of FIG. 4 illustrating energy transfer in a positive excitation state according to an example embodiment.

FIG. 5B is an equivalent circuit diagram of the two balancing bridges of FIG. 4 illustrating energy transfer in a negative excitation state according to an example embodiment.

FIG. 6 is a graph illustrating bridge currents for the two modules of FIG. 4 with increasing inter-bridge voltage unbalances, according to an example embodiment.

FIG. 7 is a graph illustrating the inter-bridge balancing current for increasing inter-bridge voltage unbalances, according to an example embodiment.

FIG. 8 is a graph illustrating winding currents of a single bridge, as influenced by unbalances Δ and α according to an example embodiment.

FIG. 9 is a graph illustrating a series line for various inductors from a popular magnetics manufacturer, with each point representing one component from a given series according to an example embodiment.

FIG. 10 is a graph illustrating switching frequencies of various inductors of FIG. 9 according to an example embodiment.

FIG. 11 is a block diagram illustrating components of four modular balancing bridge modules coupled together according to an example embodiment.

FIG. 12 is a block circuit diagram illustrating two coupled modules having series coupled power sources according to an example embodiment.

FIG. 13 is a block circuit diagram illustrating two coupled modules having an isolated pair of power sources according to an example embodiment.

FIG. 14 is a block circuit diagram illustrating a module having capacitive power sources according to an example embodiment.

FIG. 15 is a block circuit diagram illustrating a module having generic power sources according to an example embodiment.

FIG. 16 is a block circuit diagram illustrating two modules, one of which has additional switches according to an example embodiment.

FIG. 17A is a block circuit diagram of a module having a three-limb core according to an example embodiment.

FIG. 17B is a block circuit diagram of a module having a three-limb core with three intra-module pairs of windings coupling six power sources according to an example embodiment.

FIG. 18A is a timing diagram illustrating synchronized switching of module switches according to an example embodiment.

FIG. 18B is a combined schematic diagram and timing diagram illustrating staggered switch timing according to an example embodiment.

### DETAILED DESCRIPTION

A non-dissipative, cascaded, modular balancing bridge can be used to automatically balance series connected energy sources, such as batteries. A modular balancing bridge in one embodiment includes four windings on a common core and an asymmetrical half-bridge. Two of the windings can be used to automatically balance voltages across two battery cells, and the remaining two windings can be arranged to magnetically cascade one bridge with a neighboring bridge, such as to automatically balance the voltage across N battery cells.

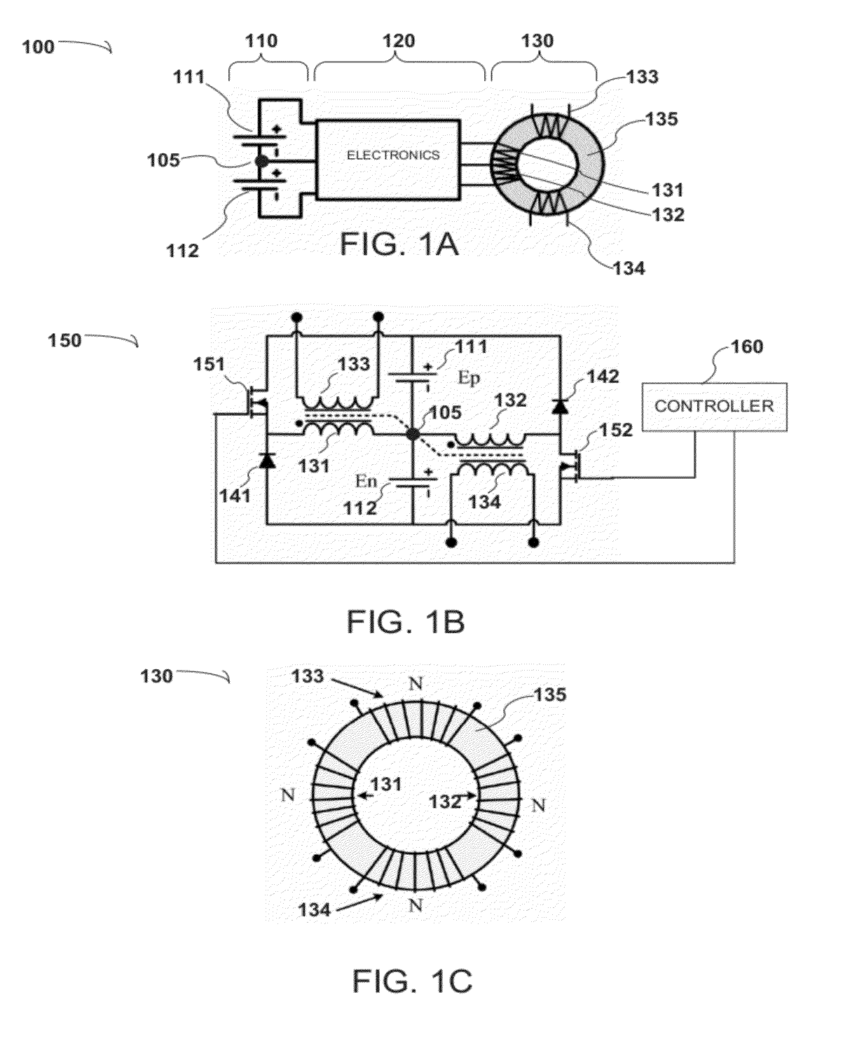

FIG. 1A illustrates generally an example of a modular balancing bridge 100. In an example, the modular balancing bridge 100 can include an energy source portion 110, a power electronics portion 120, and a transformer 130. The energy source portion 110 can include one or more battery cells 111, 112, or other voltage sources, such as capacitors or super capacitors that can be connected in series at a mid-point connection 105. The energy source portion 110 can be electrically coupled to the power electronics portion 120. In an example, the power electronics portion 120 can be electrically coupled to the transformer 130, such as using one or more windings 131, 132. The transformer 130 can include additional windings 133, 134, such as can be configured to be electrically coupled with a corresponding winding on an adjacent modular balancing bridge. In an example, the transformer 130 can include a single core 135, such as a toroidal core.

In one embodiment, a modular balancing bridge 100 may be referred to as a module, which can be coupled via the additional windings 133 and 134 to corresponding windings on one or more adjacent modules. The additional windings 133 and 134 are referred to as inter-module windings, while the windings 131 and 132 may be referred to as intra-module windings. Each of the coupled modules in one embodiment contains the same number of power sources coupled in the same manner such that the modules balance the voltages of each of the power sources in each of the modules, exchanging current between modules via the inter-module windings, and sharing current to balance voltages of the internal energy sources via the intra-module windings.

FIG. 1B illustrates generally an example of a circuit topology of a single modular balancing bridge 150 for coupling to multiple energy sources. The single modular balancing bridge 150 can include, among other components, an asymmetric half-bridge (e.g., comprising one or more switches or diodes), at least two energy sources (e.g., battery cells, capacitors, etc.), and a transformer, such as comprising a magnetic core with four windings. In an example, the four windings can each have an identical number of turns. The transformer 130, such as illustrated in FIG. 1C, for example, can have a first winding 131, a second winding 132, a third winding 133, and a fourth winding 134, and each of the windings 131, 132, 133, and 134, can have the same or approximately the same number of turns. In an example, the first and second windings 131, 132, can be intra-module or intra-bridge windings, such as can be configured to be coupled to the single modular balancing bridge 150 and a pair of power sources. In an example, the third and fourth windings 133, 134, can be inter-module or inter-bridge windings, such as can be configured to be coupled to one or more other modular balancing bridge circuits.

In one embodiment, the intra-module pair of windings 133, 134 are opposite each other on the magnetic core 135, and the intra-module pair of windings 131, 132 are opposite each other on the magnetic core 135 and orthogonal to the inter-module pair of windings 133, 134. This arrangement can allow for leakage reactance between the pairs of windings.

The example of FIG. 1B can include a first switch 151 coupled to the first winding 131 and a first battery cell 111, such as having a voltage Ep. A second switch 152 can be coupled to the second winding 132 and a second battery cell 112, such as having a voltage En. In an example, the first and second switches 151, 152, can be FET devices, BJT devices, IGBT devices, or other appropriate switch or switch circuit devices. In an example, one or more diodes can be incorporated into the single modular balancing bridge 150, such as a first diode 141 coupled to the first switch 151, first winding 131, and second battery cell 112. The one or more diodes can be arranged such that a demagnetization voltage in the single modular balancing bridge 150 is increased, such as explained below in the discussion of FIG. 3. In further embodiments, switches or other current control devices may be used and controlled to function equivalently to the diodes.

In an example, an average voltage, E̅p̅n̅, can be defined as an average voltage of the first and second battery cells 111, 112, or other energy cells, such as according to equation (1). An unbalance, or mismatch, between a pair of battery cells can be defined as Δ, such as according to equation (2). A base current can be determined using the average voltage and information about one or more circuit inductances, such as according to equation (3), where L_{W} is a magnetizing inductance of a single winding, and f_{S} is a switching frequency (i.e., the switching frequency at which the first and second switches 151, 152, are operated).

$$\begin{matrix}( Ep + En ) / 2 = \overline{Epn} & ( 1 ) \\ Δ = \frac{{E}_{p} - {E}_{n}}{{E}_{p} + {E}_{n}} & ( 2 ) \\ {I}_{BASE} = \frac{{E}_{BASE}}{{L}_{W} {f}_{s}} , {E}_{BASE} = \overline{Epn} & ( 3 )\end{matrix}$$

In one example, the voltages Ep and En can be balanced, such as using the single modular balancing bridge 150. In an example, voltage balancing can be maximized and the inductor 130 can be prevented from saturating. For example, the first and second switches 151, 152, can be driven using identical pulse-width modulated switching signals (e.g., provided by a controller circuit 160), such as having a duty cycle of about 50% or less. Due to a coupling between the upper (e.g., ‘p’ side of the bridge) windings and lower (e.g., ‘n’ side of the bridge) windings, the two-winding magnetizing inductance can be alternatively excited by about +2 E̅p̅n̅, and −2 E̅p̅n̅, such as every switching period, T_{S}.

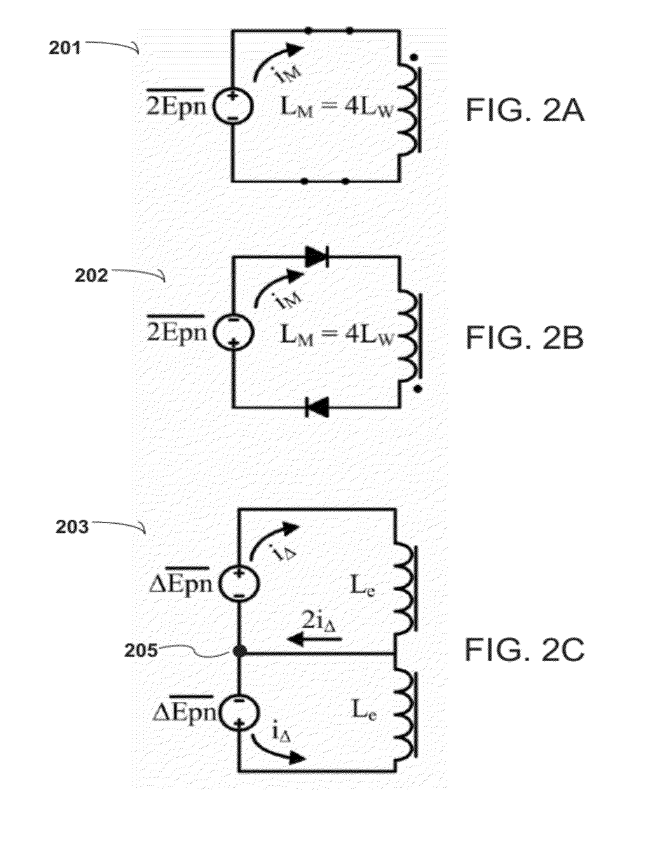

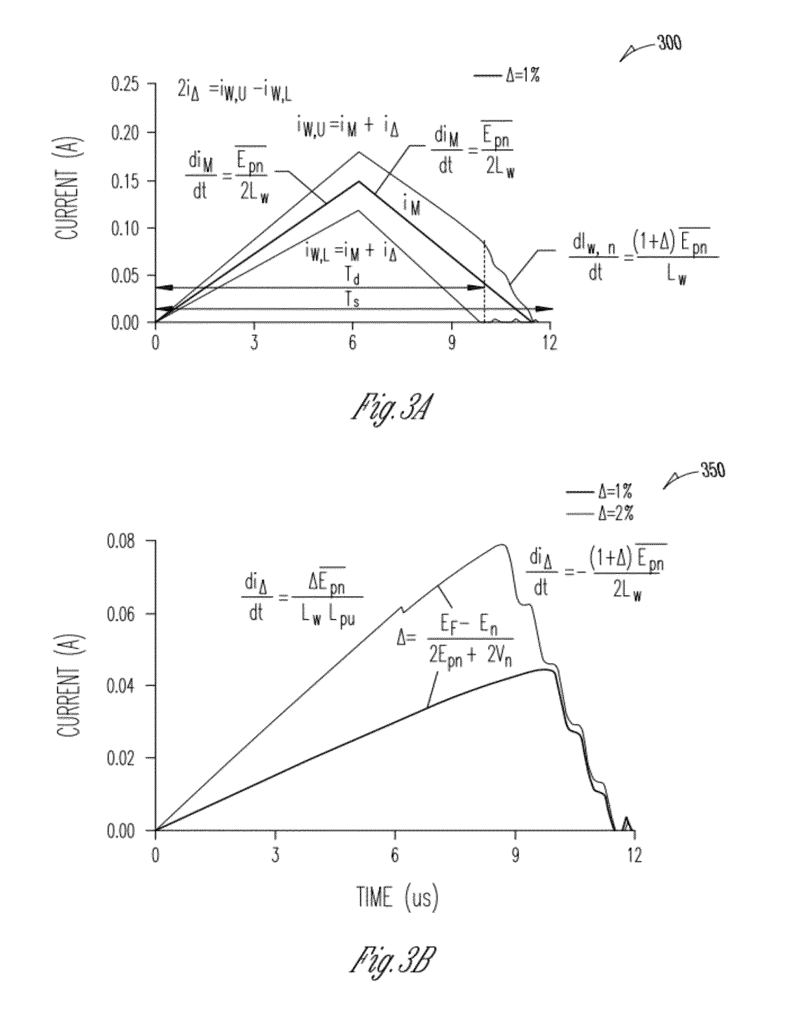

FIGS. 2A, 2B and 2C illustrate generally several equivalent circuits describing the magnetizing and intra-bridge balancing current paths of the single modular balancing bridge 150. For example, the magnetizing current path corresponding to a positive average excitation phase (e.g., +2 E̅p̅n̅) is illustrated in the first equivalent circuit 201. In this example, a magnetizing current, i_{M}, can be caused to flow through the first winding 131. In the second equivalent circuit 202, the magnetizing current path corresponding to a negative average excitation phase (e.g., −2 E̅p̅n̅) is illustrated. In the example, L_{M} can indicate a total magnetizing inductance.

FIG. 2C illustrates an example of a third equivalent circuit 203 wherein the voltage of the first battery cell 111 can differ from the voltage of the second battery cell 112. In this example, a differential voltage, Δ E̅p̅n̅, can exist across a leakage inductance, Lₑ, of the coupled inductor. The difference in cell voltage can cause an intra-balancing current, i_{Δ}, to flow, such as in addition to the magnetizing current i_{M}.

In the example of the third equivalent circuit 203, paths for both negative and positive differential currents are possible, such as causing a current of i_{M}+i_{Δ} to flow in the battery cell with the higher than average voltage, and i_{M}−i_{Δ} to flow in the opposite cell, and with 2i_{Δ} flowing into the mid-point connection 205 of the batteries. In an example, charge can be removed from the battery cell having a higher voltage (e.g., the first battery cell 111, or Ep), and can replace the charge in the battery cell having a lower voltage (e.g., the second battery cell 112, or En).

FIG. 3A illustrates generally a first time vs. current chart 300 that provides information about various parameters of the single modular balancing bridge 150. For example, for Δ=1%, FIG. 3A illustrates the winding currents (e.g., the currents flowing through the first and second windings 111, 112) with respect to the magnetizing current, i_{M}. In this example, the upper winding (e.g., the first winding 111) current can see an increase in i_{Δ}, whereas the lower winding (e.g., the second winding 112) current can see a decrease in i_{Δ}. In an example, 2i_{Δ} can return to the mid-point connection 205, and the magnetizing current can be unaffected by the unbalance A.

In an example, the intra-balancing current i_{Δ} can increase until the current in one winding becomes discontinuous, such as illustrated in the second time vs. current chart 350 in FIG. 3B. In this example, En can be (1−Δ) E̅p̅n̅, and the lower winding current magnitude can decline to about zero before the upper winding current declines to about zero, such as at time T_{d}, =Ts(1−Δ/Lₚᵤ) such as causing the upper current to demagnetize proportionally to −Ep/Lw, wherein Lₚᵤ is a ratio of Le to L_{W} in per-unit.

In an example, the average intra-balancing current, i̅_̅{̅Δ̅}̅, can be defined by equation (4). By solving equation (4) for its points of inflection, the maximum average balancing current, such as according to equation (5), can occur where Δ/Lₚᵤ is roughly 0.5. The Δ/Lₚᵤ ratio is relevant for component design/section of the balancing bridge.

$$\begin{matrix}\overline{{i}_{Δ}} = \frac{{I}_{BASE}}{4} [ \frac{Δ}{{L}_{pu}} ( 2 - \frac{Δ}{{L}_{pu}} - {( \frac{Δ}{{L}_{pu}} )}^{2} ) ] & ( 4 ) \\ {( \overline{{i}_{Δ}} )}_{max} \approx 0.156 \cdot {I}_{BASE} for Δ / {L}_{pu} \approx 0.54 & ( 5 )\end{matrix}$$

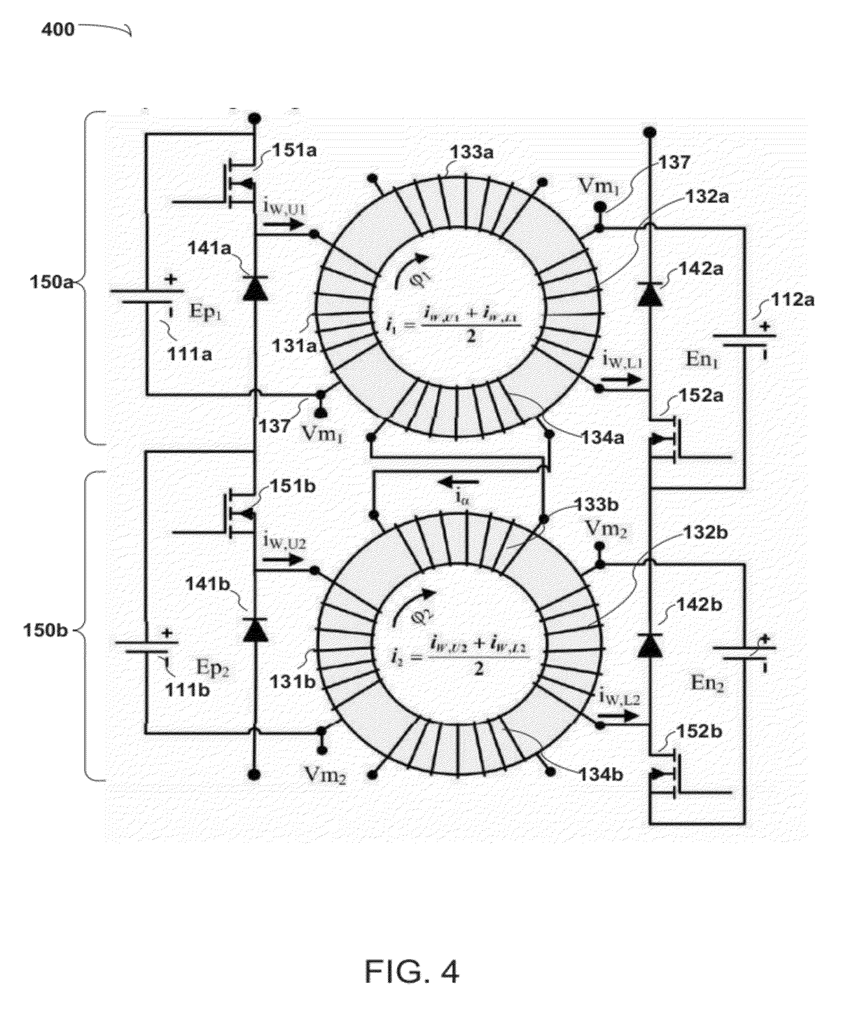

FIG. 4 illustrates generally a system 400 that can include more than one modular balancing bridge, each of which may be referred to as a module. For example, the system 400 can include a first modular balancing bridge 150a coupled to an adjacent second modular balancing bridge 150b, such as connected in series.

The first modular balancing bride 150a includes inter-module windings 133a and 134a, along with intra-module windings 131a and 132a. Similarly, the second modular balancing bridge 150b includes inter-module windings 133b and 134b, along with intra-module windings 131b and 132b. Each of the windings shares a common core in each of the modules. In this embodiment, balancing between the modules 150a and 150b occurs using adjacent windings 134a and 133b. The adjacent windings 134a and 133b have their ends cross connected as illustrated, such as to ensure synchronized excitation of the correct polarity.

In one embodiment, module 150a includes a power source 111a coupled in series with a switch 151a and a first end of winding 131a. A current control device, such as a diode 141a is coupled between the switch 151a and first end of winding 131a. The second end of winding 131a is coupled to the power source 111a, creating a series circuit that includes the power source 111a, switch 151a, and winding 131a. A similar series circuit is formed with power source 112a, switch 152a, and winding 132a. A current control device 142a is also coupled to both switch 156a and winding 132a. Note also, the windings 131a and 132a are electrically coupled as indicated at 410, and labeled Vm₁ at corresponding ends of each of the windings.

Module 150b contains similar series circuits with power source 111b, switch 151b, and winding 131b, and with power source 112b, switch 152b and winding 132b. When the modules are coupled to each other to balance the power sources in multiple modules, an inter-module series circuit is formed that includes the switches and current control devices for the respective power sources. One inter-module series circuit includes the current control devices 141b and 141a, along with the switches 151a and 151b. A further inter-module series circuit includes the current control devices 142b and 142a, along with the switches 152a and 152b. A further electrical connection is made between the windings 134a and 133b. The ends of the windings are cross coupled in one embodiment. Each open inter-module winding may be used to couple yet a further module in the same manner that the modules 150a and 150b are coupled, resulting in an even longer string of inter-module series circuits.

In an example, as explained above, an unbalance A can be prevented from influencing the magnetization of the core 135. The average voltage of a modular balancing bridge circuit is relevant when considering the interaction of two or more such bridge circuits. In an example, the average of the two adjacent module battery voltages, E̅₁̅₂̅, can be determined according to equation (6). A voltage imbalance, α, can be determined according to equation (7).

E̅₁̅₂̅=( E̅p̅n̅₁̅+ E̅p̅n̅₂̅)/2 (6)

α=( E̅p̅n̅₁̅− E̅p̅n̅₂̅)/( E̅p̅n̅₁̅+ E̅p̅n̅₂̅)

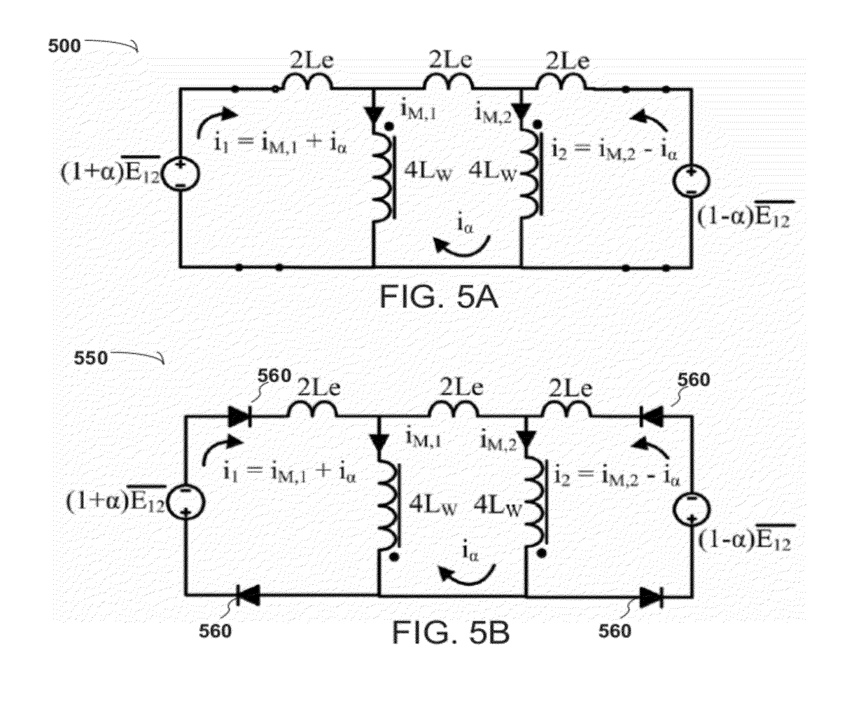

Equivalent circuits illustrating the system 400 are presented in FIGS. 5A and 5B. Circuit 500 corresponds to an equivalent circuit for inter-bridge energy transfer in a positive excitation state, and circuit 550 corresponds to an equivalent circuit for inter-bridge energy transfer in a negative excitation state. In circuit 550, several diodes 560 are shown coupled in series on either side of the voltage sources.

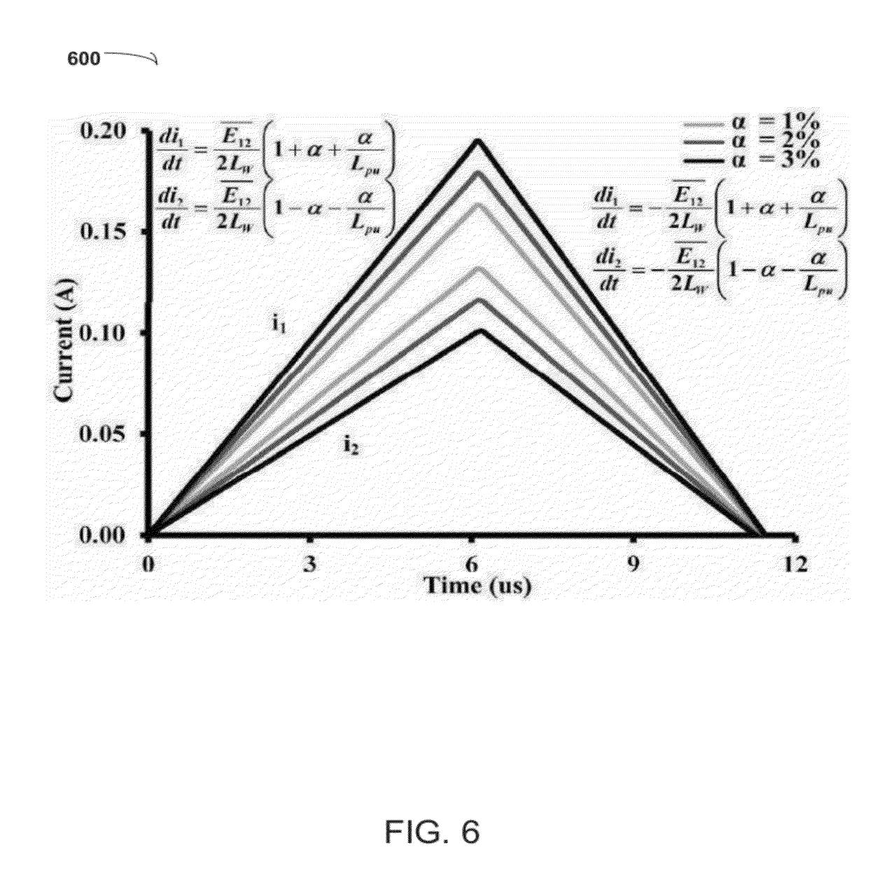

FIG. 6 illustrates generally a third time vs. current chart 600. The chart 600 indicates bridge currents for the first modular balancing bridge 150a and the second modular balancing bridge 150b, such as corresponding to increasing α. In this example, T_{S}=12 μs, L_{W}=78.6 μH, E₁₂=4V, and Lₚᵤ=10%. In the example of FIG. 6, an increasing a can represent a larger average voltage in the first modular balancing bridge 150a than in the second modular balancing bridge 150b, such as can result in a larger peak bridge current in the first modular balancing bridge 150a (i₁) and a smaller peak bridge current in the second modular balancing bridge 150b (i₂). In an example, each bridge current, i_{N}, can be the average of the upper and lower winding currents for that respective bridge, and its rise and fall times can be limited by, e.g., one or more of the leakage inductance, Lₑ, or the winding inductance, L_{W}. In an example, each bridge current can also be expressed as a sum of the magnetizing current and the balancing current, i_{α}.

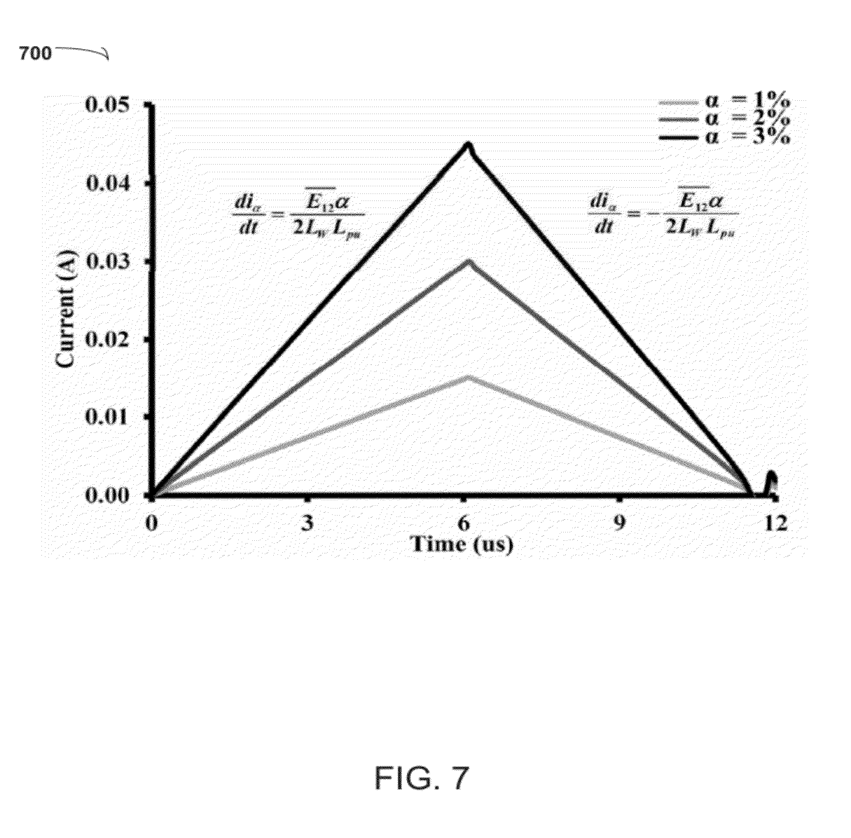

In an example, the balancing current, i_{α} can be related to the average unbalance, a, such as illustrated in FIG. 7. Unbalances of 1%, 2%, and 3% are illustrated for i₁ and i₂ of respective bridges 150a and 150b. In this example, T_{S}=12 μs, L_{W}=78.6 μH, E₁₂=4V, and Lₚᵤ=10%. The average balancing current delivered to correct the unbalance between the two bridges can be determined using equation (8), and can be derived from the average of the waveform illustrated in FIG. 7. In an example, because the maximum average balancing current, ( i̅_̅{̅Δ̅}̅)ₘₐₓ, can occur when Δ/Lₚᵤ is about 0.5, as described above, the ratio α/Lₚᵤ can be chosen to be about 0.5 as well, such as resulting in the maximum average balancing current determined using equation (9).

$$\begin{matrix}\overline{{i}_{α}} = \frac{{I}_{BASE}}{8} ( \frac{α}{{L}_{pu}} ) & ( 8 ) \\ {( \overline{{i}_{α}} )}_{max} = {I}_{BASE} / 16 for α / {L}_{pu} = 0.5 & ( 9 )\end{matrix}$$

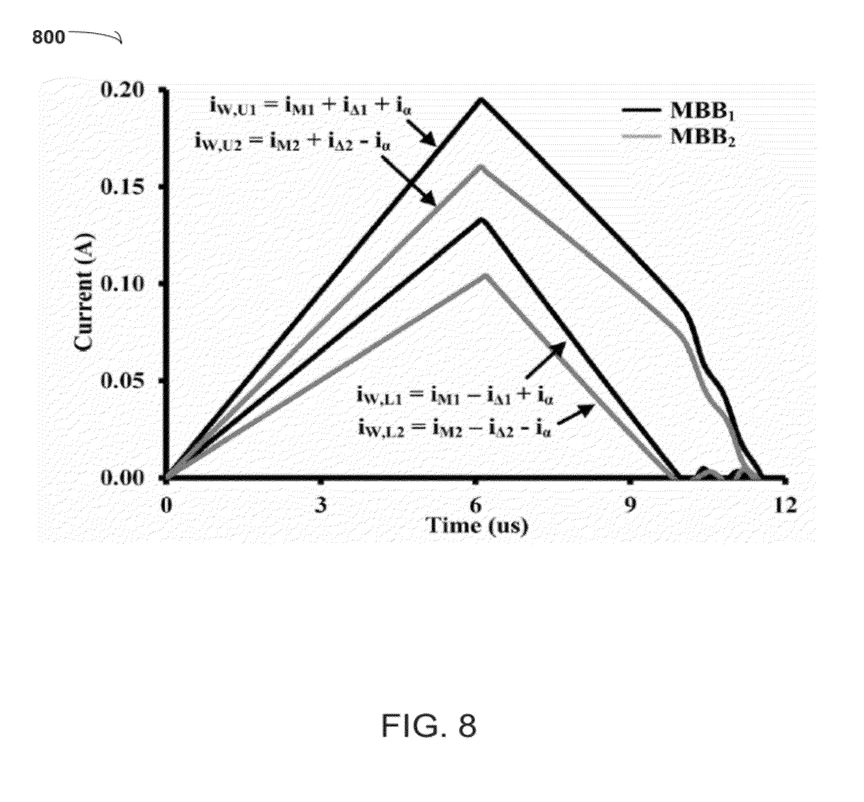

In one example, the winding currents corresponding to each bridge can be influenced by Δ and α. FIG. 8 illustrates this influence graphically. In this example, T_{S}=12 μs, L_{W}=78.6 μH, E₁₂=4V, and Lₚᵤ=10%. In the example of FIG. 8, the upper and lower winding currents for each bridge is demonstrated with Δ=1% and α=1%. As indicated in the example of FIG. 8, the RMS of a winding current ultimately dictates the copper losses in each coupled inductor and the power electronic stresses in the asymmetrical bridge. Furthermore, FIG. 8 illustrates generally that as both unbalance factors α and Δ trend to their respective maxima, the upper and lower winding currents can trend towards twice the peak of the magnetizing current and zero, respectively.

In one embodiment, the ratio of the per-unit leakage inductance, Lₚᵤ, to the unbalances Δ and α, sets a maximum limit for the average balancing current that can flow in each case. This maximum balancing current may be limited by the base current, I_{BASE}, which depends on the selected winding inductance, L_{W}, and the switching frequency, f_{S}. By inspection of FIG. 5, the peak magnetizing current is defined, (10), and since the maximum winding current is twice the magnetizing current, the maximum RMS winding current is expressed, (11).

$$\begin{matrix}{\hat{i}}_{M} \approx \frac{{I}_{BASE}}{4} ( 1 + α ) & ( 10 ) \\ {i}_{W , RMS} \approx \frac{{I}_{BASE}}{2 \sqrt{3}} ( 1 + α ) & ( 11 ) \\ W \cdot h = 2 {{E}_{BASE} ( \overline{{i}_{ɛ}} )}_{max} , where ɛ = α or Δ & ( 12 )\end{matrix}$$

Thus, with the use of (10) and (11), the key components for the design of the coupled inductor and the associated power electronics can be selected. However, since cost is a typical limiting factor in transformer-based balancing circuits, the coupled inductor of the modular balancing bridge is intended to be identical for each bridge in one embodiment, and therefore available as an “off the shelf” component. In one embodiment, the approximate relationship between the peak balancing energy, the mass of the individual coupled inductor per MBB and the switching frequency of the FET modules is described. Coupled inductors having six-windings with a 1:1 ratio on a single ferrite core may be used. Two pairs of intra-balancing windings are placed in parallel to increase the current rating of the component, while the remaining windings are used as the inter-balancing windings.

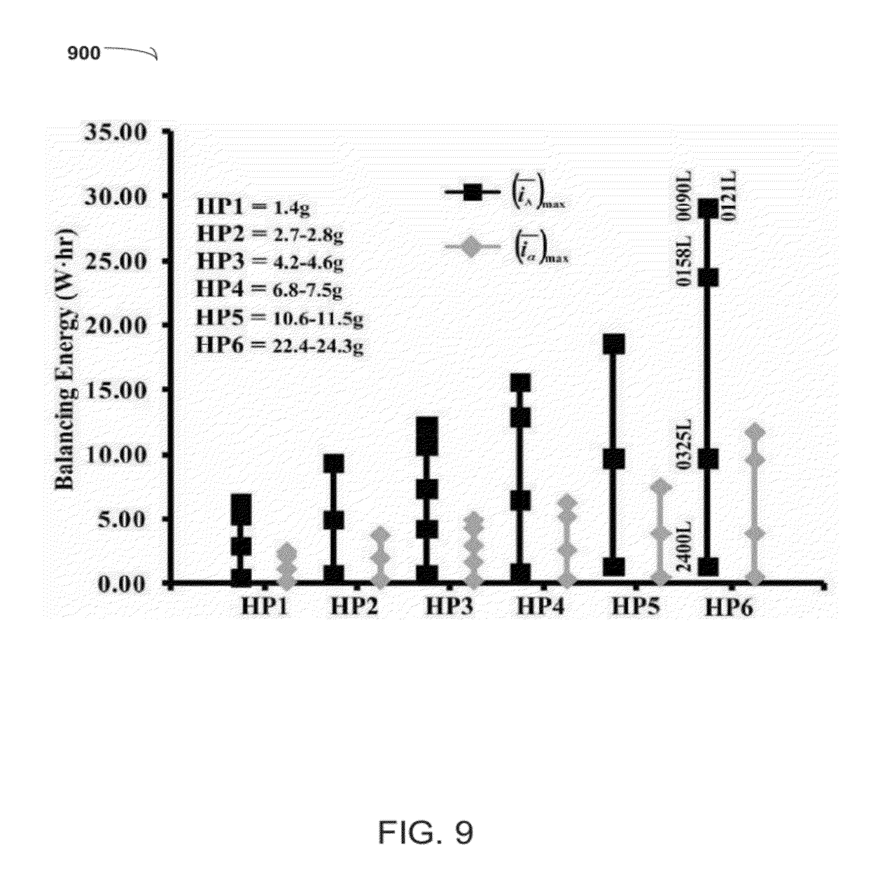

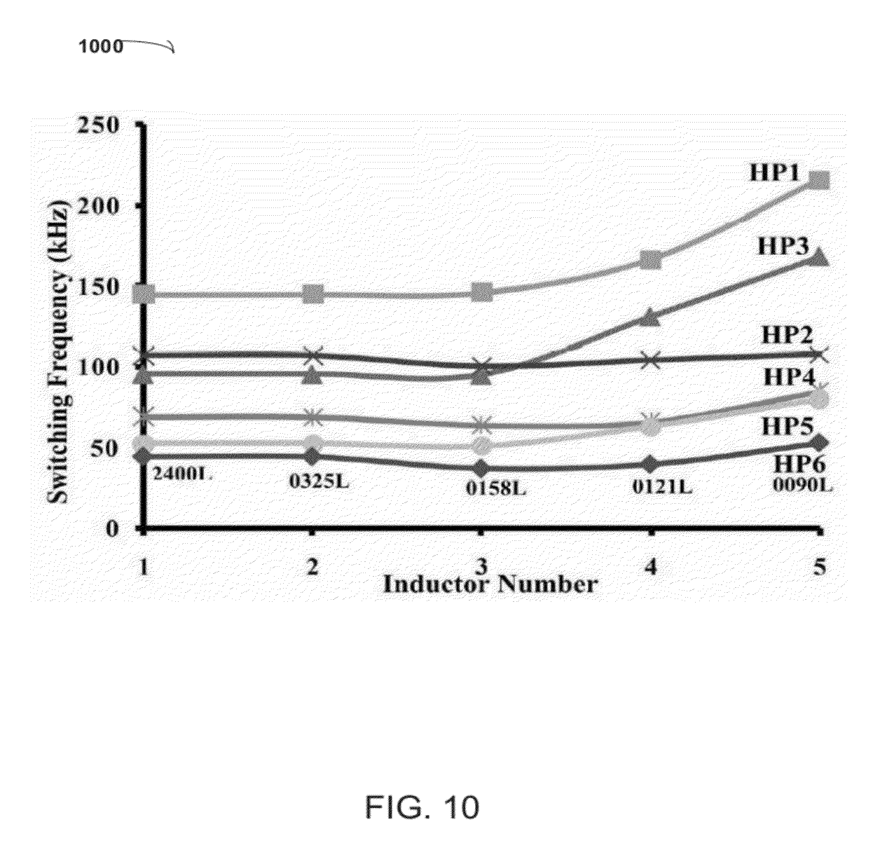

In order to compare the approximate peak balancing energy, assuming a maximum unbalance of Δ=α=5%, (0.4V with E_{BASE}=4V) a spreadsheet can be created using (6), (10), (11) and (12), such as using several ‘hexa-path’ inductors, available from a popular magnetics manufacturer, for illustrative purposes. The resulting balanced energies are illustrated in a bar chart in FIG. 9. The maximum switching frequency can be calculated by limiting the peak saturation current and keeping the temperature rise of each inductor below 40° C., such as illustrated in a graph of switching frequency versus inductor number in FIG. 10. The maximum balancing energy is obtained from (12): FIG. 9 illustrates the series line from HP1 to HP6, with each point on the figure representing one component from a given series (ie: HP6-2400L, HP6-0325L, etc.). From FIG. 9, while the Δ balancing energy is more than double that for the a balancing energy, a clear trend exists with increasing balancing energy for increasing inductor mass. It should be noted that the lowest points in FIG. 9, such as for each range (i.e. HP6-2400L), feature no air-gap in the transformer and consequently contribute little peak balancing energy. However, doubling the magnetic mass will not halve the peak balancing energy (and therefore reduce the time to charge).

Although the smallest cores can result in a relatively high peak balancing energy, the required switching frequency of the FET modules to obtain this energy transfer (and therefore the efficiency of the converter) should be taken into account. FIG. 10 illustrates the switching frequency of the FET modules to obtain the balancing rate for each inductor given in FIG. 9. The figure illustrates that in order to keep the effective RMS current below rated, the coupled inductors with the largest air-gap use a significantly larger switching frequency (number 5) than the middle inductors (number 3); yet for the smaller inductors (e.g. HP1), e.g., from FIG. 9, the peak balancing energy is nearly identical between the middle inductors (number 3) and the top inductors (numbers 4 or 5).

Since the automatic battery cell voltage correction relies on the synchronized excitation of each core, non-ideal behavior typically presents in practical implementations and can impact the rate of balancing. One such non-ideal behavior is a control signal delay, such as between FETs, or asymmetric switching characteristics, such as a difference in turn-off times between adjacent switches in a module. This turn-off difference can arise due to variable switching delays, or device capacitance changing due to excessive current differences between a pair of FET modules. Regardless of the reason behind the FET turn-off time mismatch (turn-on mismatch does not generally have the same effect due to the winding currents both being zero at turn on), it manifests in the MBB operation as a sharp drop of i_{drop}, in the upper winding current and an increase of i_{drop} in the lower winding current.

In an example, the mismatch of FET turn-off times can cause a differential voltage of V_{DELAY} across the leakage inductance, Lₑ, within a single modular balancing bridge. However, due to the polarity of V_{DELAY}, a counteracting current of i_{drop} is introduced against the balancing current, i_{Δ}. This same turnoff mismatch has the identical effect on reducing the average inter-balancing current, i_{α}.

In an example, the effect of turn-off time mismatch between switch modules can be reduced with increased series filter inductance to the coupled inductor. This effectively increases Lₚᵤ, allowing for larger Δ and α compensation, and decouples the design of the MBB unit from the leakage inductance, Lₑ, of each core. Furthermore, with special attention to improved FET gate drive design (such as turn-off enhancement circuits), this turn-off time mismatch can be further reduced.

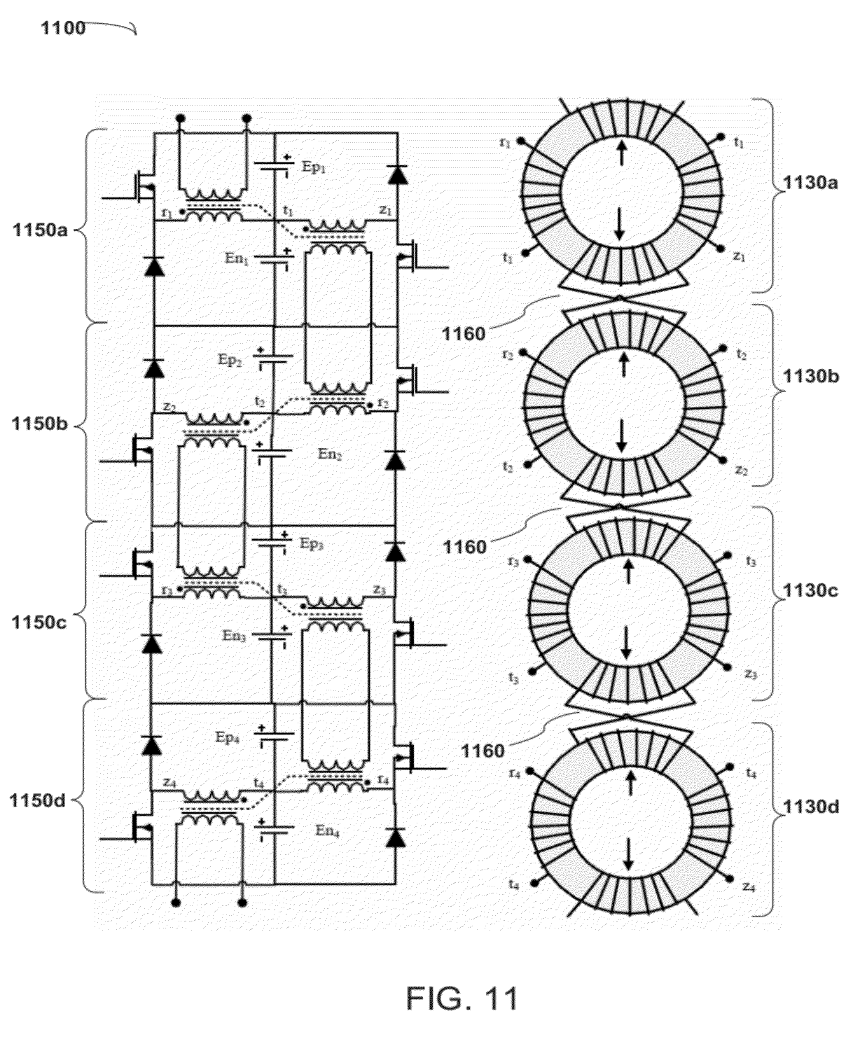

FIG. 11 is a block diagram illustrating components of four modular balancing bridge modules coupled together at 1100. The windings with respective common cores are illustrated at 1130a, 1130b, 1130c, and 1130d. Corresponding bridge topologies are illustrated at 1150a, 1150b, 1150c, and 1150d. The topologies may be coupled to power sources of many different types as described above. Inter-module windings in the coils are cross coupled in one embodiment to form inter-bridge connections 1160 to share current between modules and balance voltages across all power sources coupled to the modules. Ends of intra-module windings are labeled with subscripted letters r, t, and z in both the illustrated cores and corresponding topologies.

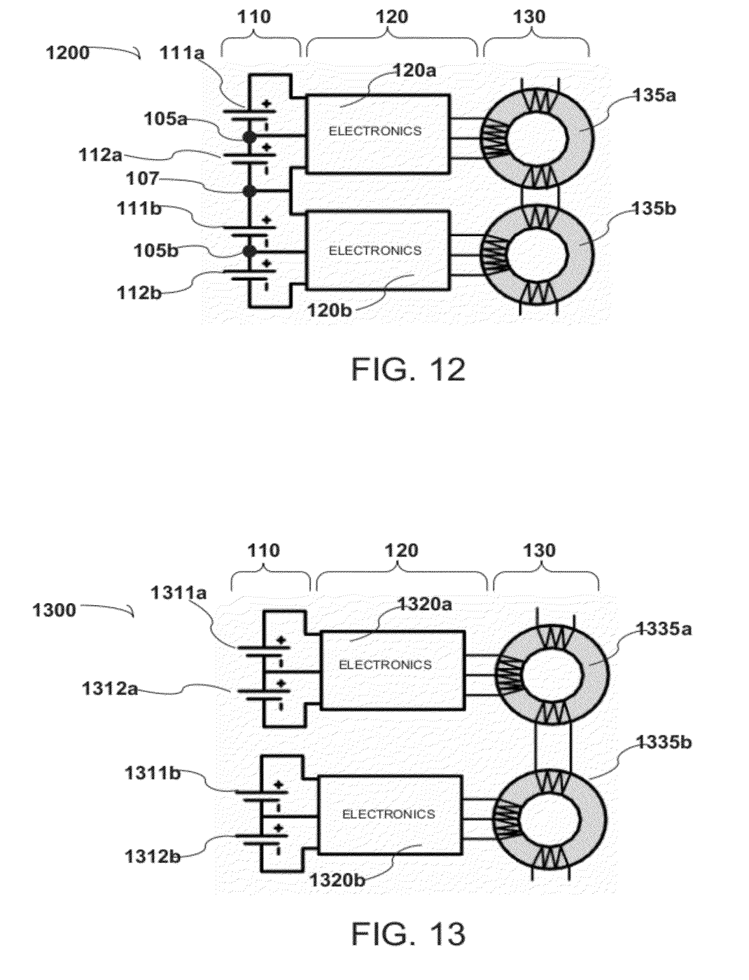

FIG. 12 is a block diagram illustrating at 1200 two coupled modules 120a and 120b. Each module corresponds to a pair of power sources, 111a, 112a, and 111b, 112b, coupled in series within the modules as illustrated at 105a and 105b respectively, and also coupled in series between the modules as indicated at 107. This configuration creates four voltage-balanced power sources, coupled in series such as to provide a higher voltage than a single power source. Each module has its own common core (e.g., cores 135a and 135b) for intra-module windings and inter-module windings.

FIG. 13 is a block diagram illustrating at 1300 two coupled modules 1320a and 1320b. In this embodiment, each module has series coupled pairs of power sources 1311a, 1312a and 1311b, 1312b, but the power sources are isolated between the modules. While the modules share balancing current between them via the inter-module windings at the cores 1335a and 1335b, there is no series connection between the power sources in the different modules 1320a and 1320b.

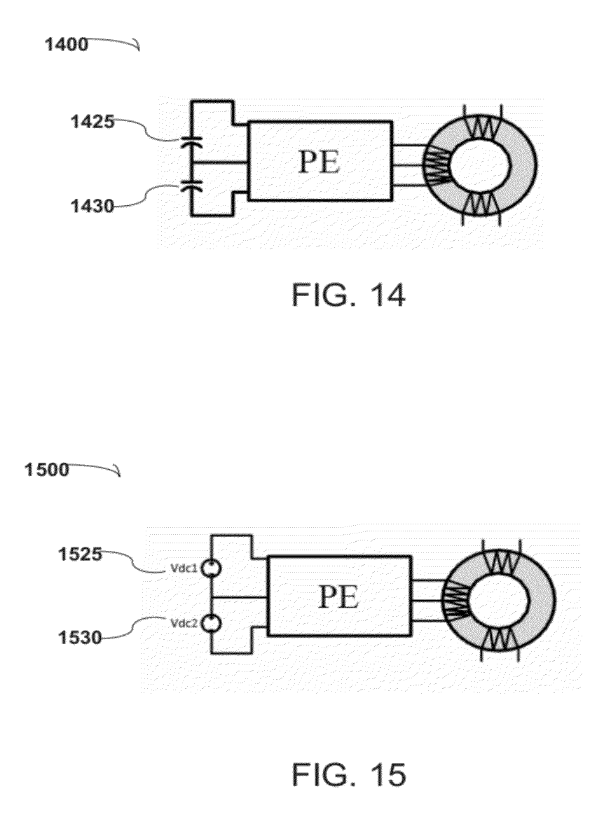

FIG. 14 is a block diagram illustrating a module 1400 having capacitors 1425 and 1430 as the power sources. The voltage balancing effect operates well with capacitors or any arbitrary voltage sources 1525, 1530, such as indicated in FIG. 15 for module 1500.

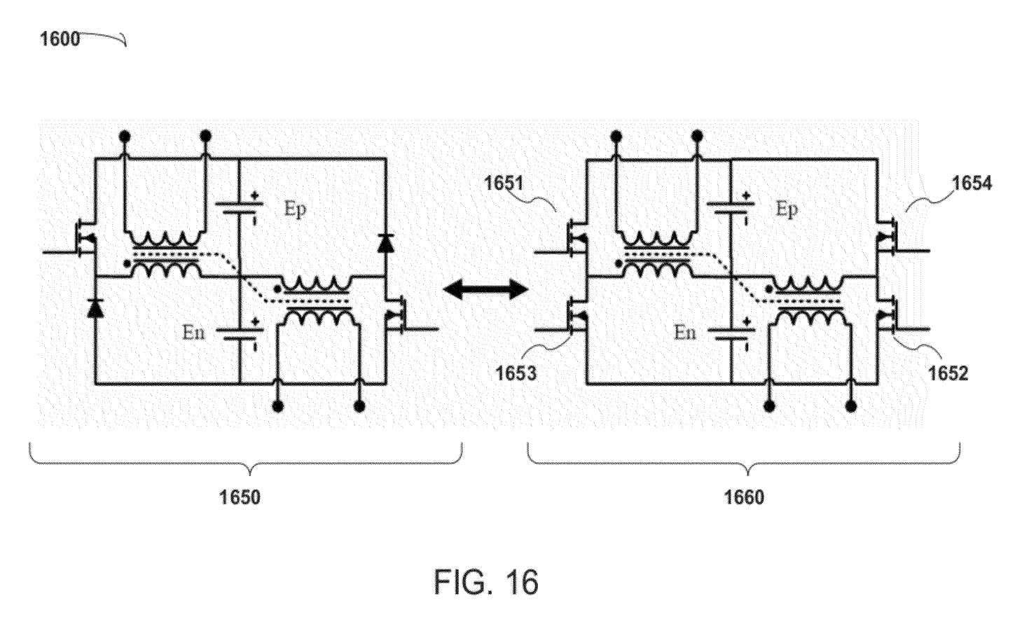

In one embodiment 1600 illustrated in FIG. 16, diodes in a power electronic converter or balancing module 1650 may be replaced with switches 1652 and 1654 as illustrated in converter 1660. While using twice the number of switches (e.g., as compared to the module 1650), the magnetic mass of the module's transformer core can be reduced, such as resulting in a reduction of transformer size and weight, by removing the DC offset in the bridge currents and thereby eliminating the DC flux in each transformer core. In this arrangement, adjacent switches (upper and lower switches on either side of the transformer) can be pulse-width modulated in a complimentary fashion while the diagonal switches can be pulse-width synchronously modulated, such as in a similar fashion as in the asymmetric version of the bridge.

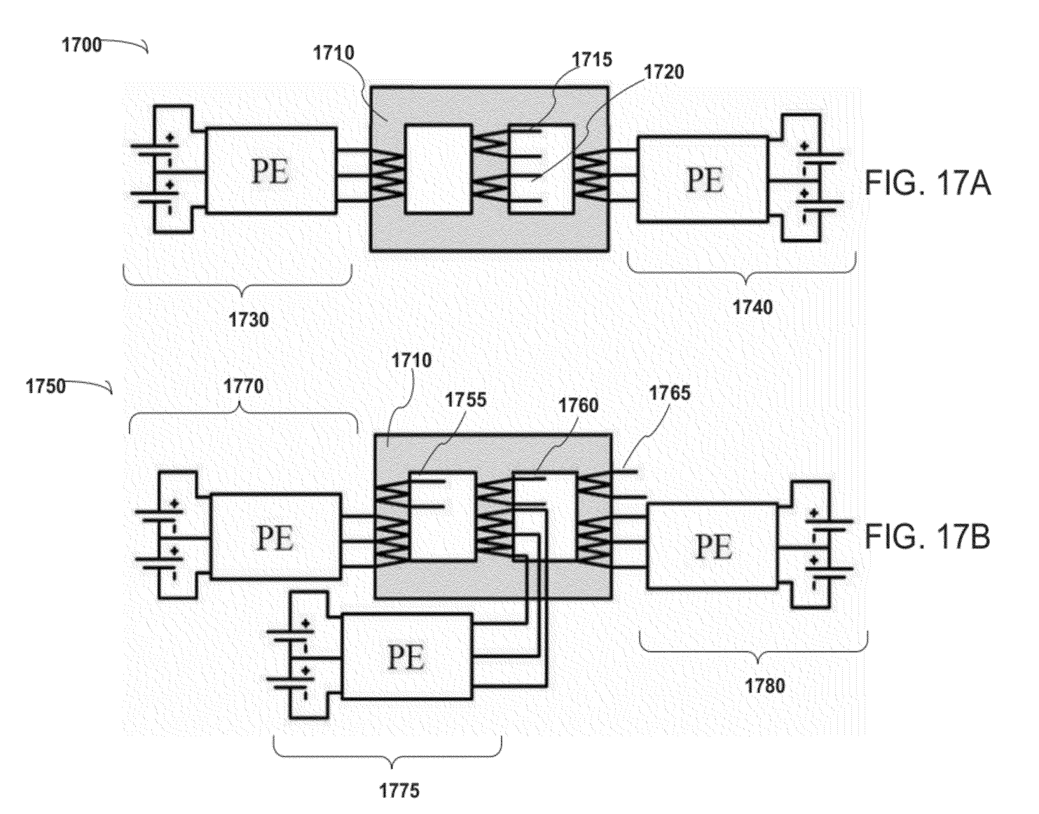

FIG. 17A illustrates a module 1700 having a three limb core 1710. A middle core contains inter-module windings for coupling to other modules as indicated at 1715 and 1720. Two electronics portions 1730 and 1740 are shown coupled to intra-module windings on the outer two limbs of the three limb core 1710, for balancing voltages of power sources. In one embodiment, each set of windings has an equal number of turns.

FIG. 17B illustrates a module 1750 having a three-limb core 1710. Each of the limbs of the core has an intra-module winding 1755, 1760, and 1765, for coupling respective electronics portions 1770, 1775, and 1780, respectively. Each of the electronics portions contains two coupled power sources in one embodiment. Module 1750 thus operates to balance voltages of six total power sources coupled to three different electronics portions. In further embodiments, multiple more electronics portions may be coupled to a core in a symmetrical manner. Thus, each module may have multiple power sources, and may also be coupled to multiple other modules in various embodiments providing a high degree of freedom for designing systems with different capacities.

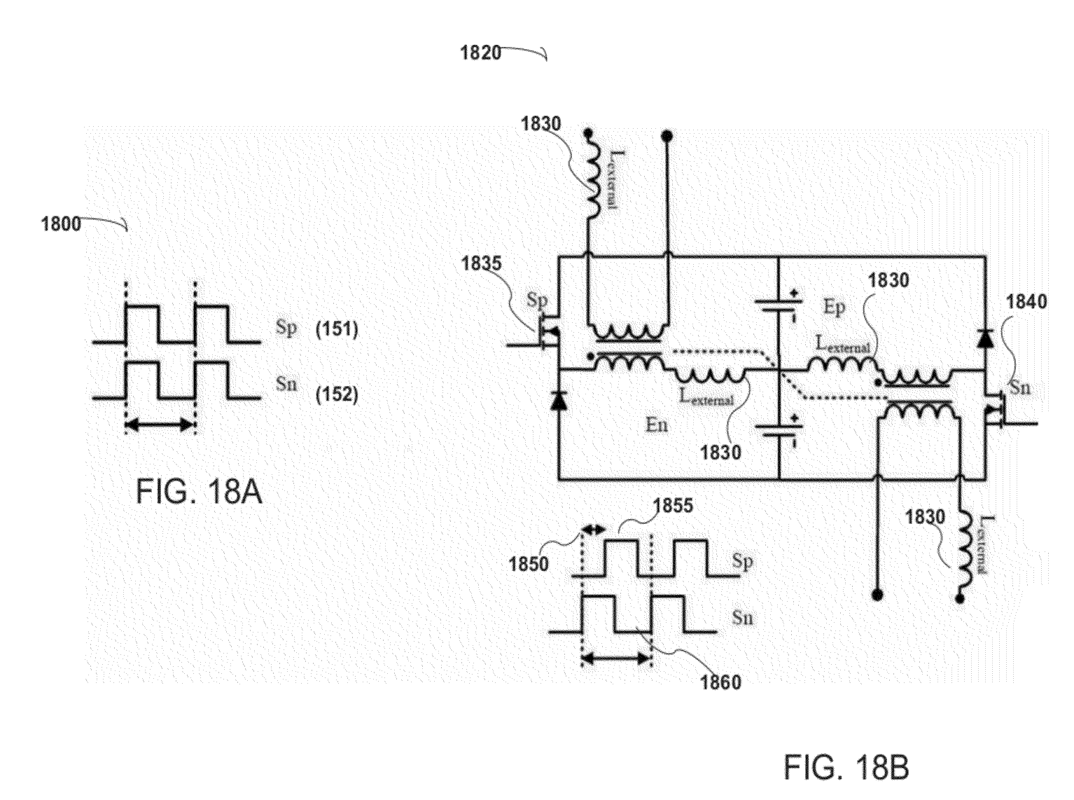

FIG. 18A at 1800 illustrates control signals, such as can be used for switching or controlling the switches 151 and 152 of the circuit in FIG. 1B. In one embodiment, the control signals are provided by the controller 160 as illustrated in FIG. 1B. In FIG. 18A, the control signals are identical for each switch.

In FIG. 18B, non-synchronized switching is illustrated at 1810, along with a circuit diagram 1820 of a module that includes external inductances (e.g. increased L_{PU}) 1830. The module 1820 includes two switches 1835 and 1840 to couple to power sources. The switches are controlled to be on and off in a manner that provides a changing current to the intra-module core windings. In one embodiment, an intentional delay 1850 is introduced between the start of pulses 1855 to turn switch 1835 on and off, and the start of pulses 1860 to turn switch 1840 on and off. This intentional delay 1850 may also be used to combine a closed loop voltage control mode and an automatic balancing mode in further embodiments.

In some embodiments, one or more intentional delays or interleaving of pulses may be used in one or more modules to stagger the operation of the switches, which can result in a reduction of radiated EMI. The start of pulses 1855 and 1860 is delayed about one quarter of a cycle in a module with two switches in one embodiment. In further embodiments, a module having four switches may employ a single delay for controlling two of the four switches, or may have three delays staggered to result in each switch being controlled to switch on and off at different times from each other. The same concepts can be applied to multiple modules coupled together. Groups of switches may be controlled such that half the switches switch follow a single delay period, or various numbers of switches may switch at staggered times as desired.

A modular converter is presented that uses the natural leakage inductance of a four-winding coupled inductor to control the voltage balancing of serially connected batteries. While a system with a limited number of cells has been described in various embodiments for simplicity of explanation, the modular converter may be used for large battery strings, such as can be used for transportation applications (e.g., electric vehicles). The batteries may be coupled in series or in parallel within modules and between modules, such as to obtain desired voltage and current levels for many different applications. In one embodiment, each module contains the same number of power sources coupled in the same manner, and each core and sets of core windings are the same both within and between each module that is coupled. The balancing action allows for minimized control hardware, and, coupled with the modular nature of the converter system, cost effectiveness for traditionally costly, non-dissipative balancing systems.

The power sources in various embodiments may include lead-acid, nickel cadmium (NiCd), nickel metal hydride (NiMH), lithium ion (Li-ion), and lithium ion polymer (Li-ion polymer) and other rechargeable batteries, as well as other non-battery power sources.

### Various Notes & Examples

Example 1 includes subject matter (such as an apparatus or a balancing bridge module) comprising a magnetic core, an intra-module pair of windings around the core, each to couple to a separate voltage source, and at least one inter-module winding around the core to couple to an adjacent balancing module. In Example 1, each of the intra-module and inter-module windings can have an equal number of turns and can operate to balance voltages between the separate voltage sources and an adjacent module, if coupled.

In Example 2, the subject matter of Example 1 can optionally include an inter-module pair of windings around the core, wherein each inter-module winding is configured to couple to an adjacent balancing bridge module.

In Example 3, the subject matter of one or any combination of Examples 1-2 can optionally include the intra-module pair of windings disposed opposite each other on the magnetic core, and the inter-module pair of windings disposed opposite each other on the magnetic core, and the inter-module pair can be substantially orthogonal to the intra-module pair of windings.

In Example 4, the subject matter of one or any combination of Examples 1-3 can optionally include a second balancing module that has at least one second inter-module winding, wherein first and second winding leads of the first inter-module winding and first and second winding leads of the second inter-module winding can be cross-coupled or cross-connected together.

In Example 5, the subject matter of one or any combination of Examples 1-4 can optionally include a toroidal magnetic core.

In Example 6, the subject matter of one or any combination of Examples 1-5 can optionally include a monolithic magnetic core.

In Example 7, the subject matter of one or any combination of Examples 1-6 can optionally include a multi-limb magnetic core.

In Example 8, the subject matter of one or any combination of Examples 1-7 can optionally include a three-limb magnetic core.

In Example 9, the subject matter of one or any combination of Examples 1-8 can optionally include at least one additional pair of intra-module windings around the core, each additional winding to couple to a separate voltage source.

In Example 10, the subject matter of one or any combination of Examples 1-9 can optionally include a battery coupled to each of the intra-module windings.

In Example 11, the subject matter of one or any combination of Examples 1-10 can optionally include a pair of switches, each switch is electrically coupled to one of the voltage sources and to a respective winding.

In Example 12, the subject matter of Example 11 can optionally include a second pair of switches, each of the second pair of switches is electrically coupled to a corresponding one of the first pair of switches and to one of the voltage sources.

In Example 13, the subject matter of one or any combination of Examples 11 or 12 can optionally include operating the switches at a duty cycle of up to about 50%.

In Example 14, the subject matter of one or any combination of Examples 11-13 can optionally include a pair of current flow controllers, each current flow controller is electrically coupled to at least one of the switches and at least one of the voltage sources.

In Example 15, the subject matter of one or any combination of Examples 11-14 can optionally include at least one winding that is electrically coupled at a node that joins at least one of the switches and at least one of the current flow controllers, and wherein the at least one current flow controller is configured to permit current flow between at least one of the voltage sources and the winding when the at least one switch is on.

In Example 16, the subject matter of one or any combination of Examples 11-15 can optionally include a second balancing module, wherein a current flow controller in the first balancing module is electrically coupled to a current flow controller in the second balancing module, and wherein a switch in the first balancing module is electrically coupled to a switch in the second balancing module.

In Example 17, the subject matter of one or any combination of Examples 11-16 can optionally include a configuration wherein each switch is connected in series with one of the voltage sources and one of the windings.

In Example 18, the subject matter of one or any combination of Examples 1-17 can optionally include a first node is coupled to (1) a negative terminal of the first voltage source, (2) a positive terminal of the second voltage source, and (3) at least one terminal of each winding of the intra-module pair of windings.

Example 19 can include, or can optionally be combined with the subject matter of one or any combination of Examples 1-18 to include, subject matter (such as a method, a means for performing acts, or a processor-readable medium including instructions that, when performed by the processor, cause the processor to perform acts) comprising balancing, in a first module, a first intra-module voltage among multiple voltage sources, providing an inter-module balancing current to a second module, and balancing, in the second module, a second intra-module voltage among multiple other voltage sources, wherein the balancing in the second balancing module includes using the inter-module balancing current.

In Example 20, the subject matter of Example 19 can optionally comprise balancing of the first intra-module voltage in the first module using a first pair of windings that are wound around a common magnetic core.

In Example 21, the subject matter of one or any combination of Examples 19 or 20 can optionally comprise providing the inter-module balancing current, such as by inducing the inter-module balancing current in a third winding that surrounds the magnetic core.

Example 22 includes subject matter (such as an apparatus or a balancing bridge module) comprising a magnetic core, an intra-module pair of windings around the core, each to couple to a separate voltage source, and an inter-module pair of windings around the core, each to couple to an adjacent module, wherein windings of each of the intra-module and inter-module pairs of windings has an equal number of turns and operates to balance voltages between the separate voltage sources and each adjacent module if coupled.

Example 23 includes subject matter (such as an apparatus or a balancing bridge module) comprising a magnetic core, an intra-module pair of windings around the core, each coupled to a separate voltage source, and at least one inter-module winding around the core to couple to an adjacent balancing module. Example 23 can optionally include a pair of switches, each switch coupled between a respective one of the intra-module pair of windings and a respective voltage source, or a controller coupled to turn the switches on and off in a time staggered manner.

In Example 24, the subject matter of Example 23 can optionally include using the controller to control switches in multiple balancing bridge modules that are coupled via inter-module windings to control the switches in an interleaved, time-staggered manner, such as to minimize EMI radiation.

These non-limiting examples can be combined in any permutation or combination.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A balancing bridge module comprising:
a magnetic core;
an intra-module pair of windings around the core, each to couple to a separate voltage source; and
at least one inter-module winding around the core to couple to an adjacent balancing module;
wherein each of the intra-module and inter-module windings has an equal number of turns and operates to balance voltages between the separate voltage sources and an adjacent module if coupled.

2. The balancing module of claim 1, further comprising an inter-module pair of windings around the core, wherein each inter-module winding is configured to couple to an adjacent balancing bridge module.

3. The balancing module of claim 2, wherein the intra-module pair of windings are opposite each other on the magnetic core, and wherein the inter-module pair of windings are opposite each other on the magnetic core and substantially orthogonal to the intra-module pair of windings.

4. The balancing module of claim 2, further comprising a second balancing module that has at least one second inter-module winding;
wherein first and second winding leads of the first inter-module winding and first and second winding leads of the second inter-module winding are cross-coupled together.

5. The balancing module of claim 1, wherein the magnetic core is a toroidal magnetic core.

6. The balancing module of claim 1, wherein the magnetic core is a monolithic magnetic core.

7. The balancing module of claim 1, wherein the magnetic core is a multi-limb magnetic core.

8. The balancing module of claim 7, wherein the magnetic core is a three-limb magnetic core.

9. The balancing module of claim 1, further comprising at least one additional pair of intra-module windings around the core, each additional winding to couple to a separate voltage source.

10. The balancing module of claim 1, further comprising a battery coupled to each of the intra-module windings.

11. The balancing module of claim 1, further comprising a pair of switches, each switch is electrically coupled to one of the voltage sources and to a respective winding.

12. The balancing module of claim 11, further comprising a second pair of switches, each of the second pair of switches is electrically coupled to a corresponding one of the first pair of switches and to one of the voltage sources.

13. The balancing module of claim 11, wherein the switches are operated at a duty cycle of up to about 50%.

14. The balancing module of claim 11, further comprising a pair of current flow controllers, each current flow controller is electrically coupled to at least one of the switches and at least one of the voltage sources.

15. The balancing module of claim 14, wherein at least one winding is electrically coupled at a node that joins at least one of the switches and at least one of the current flow controllers, and wherein the at least one current flow controller is configured to permit current flow between at least one of the voltage sources and the winding when the at least one switch is on.

16. The balancing module of claim 14, further comprising a second balancing module;
wherein a current flow controller in the first balancing module is electrically coupled to a current flow controller in the second balancing module; and
wherein a switch in the first balancing module is electrically coupled to a switch in the second balancing module.

17. The balancing module of claim 11, wherein each switch is connected in series with one of the voltage sources and one of the windings.

18. The balancing module of claim 1, wherein a first node is coupled to (1) a negative terminal of the first voltage source, (2) a positive terminal of the second voltage source, and (3) at least one terminal of each winding of the intra-module pair of windings.

19. A method, comprising:
balancing, in a first module, a first intra-module voltage among multiple voltage sources;
providing an inter-module balancing current to a second module; and
balancing, in the second module, a second intra-module voltage among multiple other voltage sources;
wherein the balancing in the second balancing module includes using the inter-module balancing current.

20. A balancing bridge module comprising:
a magnetic core;
an intra-module pair of windings around the core, each to couple to a separate voltage source; and
an inter-module pair of windings around the core, each to couple to an adjacent module;
wherein windings of each of the intra-module and inter-module pairs of windings has an equal number of turns and operates to balance voltages between the separate voltage sources and each adjacent module if coupled.
